(19) United States
(12) Patent Application Publication
(10) Pub. No.: US 2019/0068900 A1
(43) Pub. Date: Feb. 28, 2019

(54) Display Component Emitting Both Visible Spectrum and Infrared Spectrum Light

(71) Applicant: Lenovo (Singapore) Pte. Ltd., Singapore (SG)

(72) Inventors: Robert J. Kapinos, Durham, NC (US); Timothy W. Kingsbury, Cary, NC (US); Russell S. VanBlon, Raleigh, NC (US)

(21) Appl. No.: 15/690,936

(22) Filed: Aug. 30, 2017

(51) Int. Cl. H04N 5/33; G02F 1/1335; H04N 5/225

(52) U.S. Cl. CPC H04N 5/33; G02F 1/133603; G02F 2203/11; G02F 1/133512; H04N 5/2256; G02F 1/133606

(57) ABSTRACT

An approach is disclosed that provides a display component that includes a backlight layer, a diffuser layer, and a liquid crystal layer. The diffuser layer diffuses light emitted from the backlight layer into both visible spectrum light as well as infrared spectrum light suitable for infrared photography.

### BACKGROUND

Infrared (“IR”) cameras generate images using infrared radiation. In infrared photography, image sensor used is sensitive to infrared light. The part of the spectrum used is referred to as near-infrared to distinguish it from far-infrared, which is the domain of thermal imaging. Wavelengths used for IR photography range from about 700 nm to about 900 nm.

Recently, manufacturers have begun integrating IR cameras in laptop computers and other information handling systems, such as tablet computer systems, etc. In addition, an IR camera accessory can be added to a traditional information handling systems to provides such systems with IR camera capabilities, much like web cams and other small digital cameras provide traditional digital photography to such information handling systems.

### SUMMARY

An approach is disclosed that provides a display component that includes a backlight layer, a diffuser layer, and a liquid crystal layer. The diffuser layer diffuses light emitted from the backlight layer into both visible spectrum light as well as infrared spectrum light suitable for infrared photography.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages will become apparent in the non-limiting detailed description set forth below.

### BRIEF DESCRIPTION OF THE DRAWINGS

This disclosure may be better understood by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a diagram depicting components of a screen that have been modified to provide infrared spectrum lighting to use with an integrated infrared camera;

FIG. 4 is a diagram depicting a diffuser implementation that uses a modified diffuser layer to emit infrared spectrum lighting from the display screen;

FIG. 5 is a diagram depicting a dual backlight implementation that uses a modified diffuser layer and additional infrared backlights to emit infrared spectrum lighting from the display screen;

FIG. 6 is a diagram depicting a blocker diodes implementation that uses a modified diffuser layer and blocker diodes incorporated in the LCD layer to emit infrared spectrum lighting from the display screen;

FIGS. 7A-7C depict various backlighting techniques that can be used as backlights to provide infrared spectrum lighting; and

FIG. 8 is a flowchart showing steps performed when providing infrared spectrum lighting utilizing the diffused, dual backlight, or blocker diodes implementations.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. As used herein, a computer readable storage medium does not include a computer readable signal medium.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

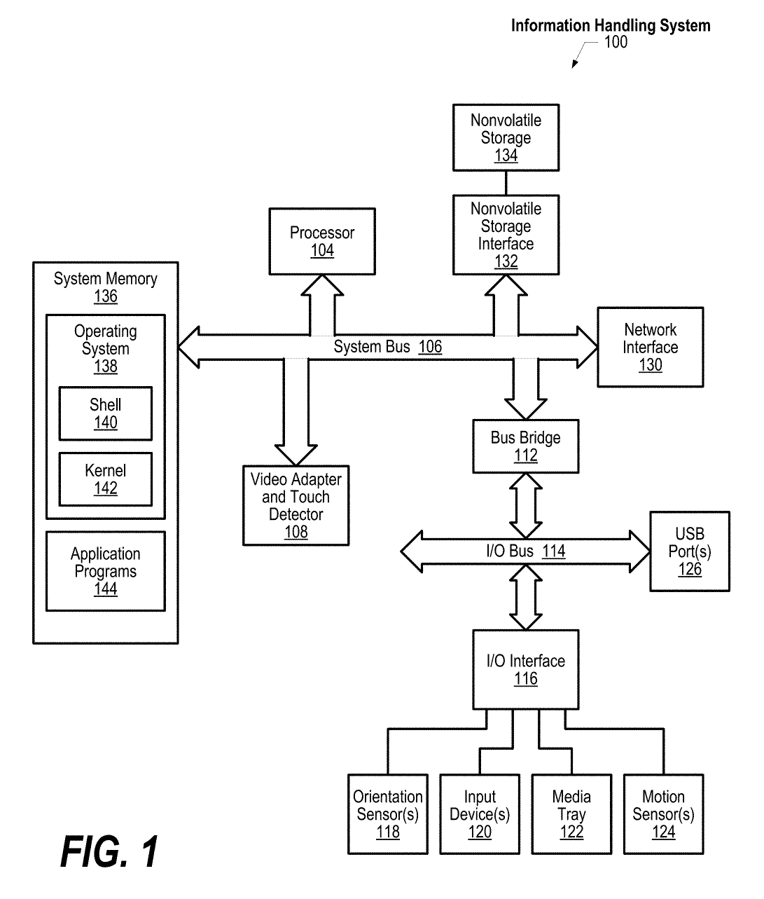

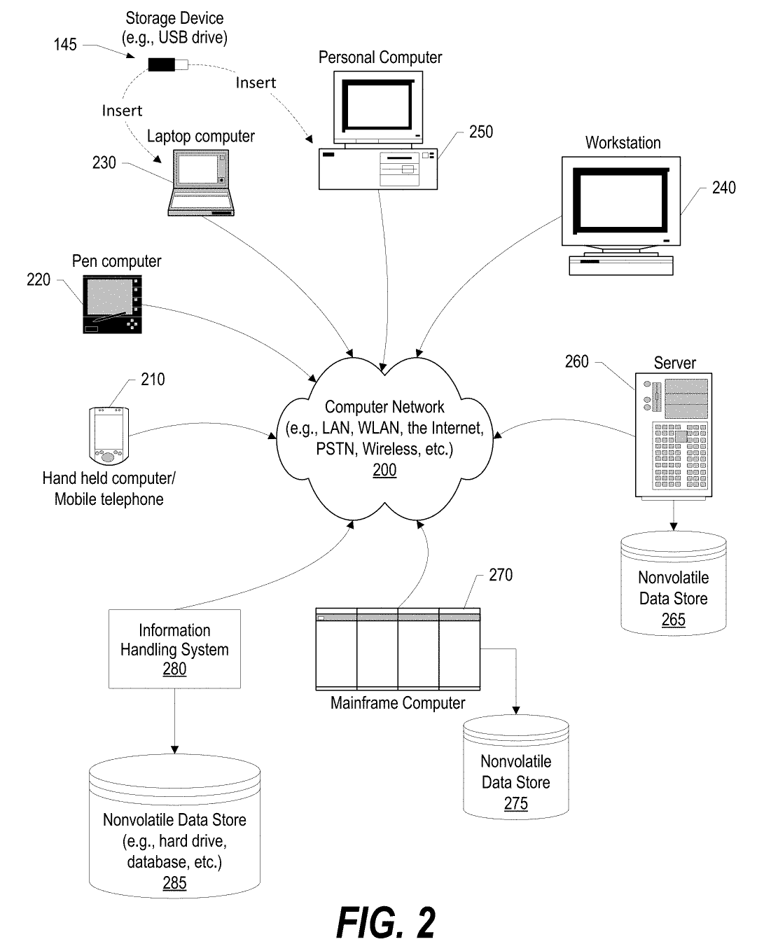

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Note that some or all of the exemplary architecture, including both depicted hardware and software, shown for and within information handling system 100 may be utilized by a software deploying server, such as one of the servers shown in FIG. 2.

Information handling system 100 includes processor 104 that is coupled to system bus 106. Processor 104 may utilize one or more processors, each of which has one or more processor cores. Video adapter 108, which drives/supports touch screen display 110, is also coupled to system bus 106. System bus 106 is coupled via bus bridge 112 to input/output (I/O) bus 114. I/O interface 116 is coupled to I/O bus 114. I/O interface 116 affords communication with various I/O devices, including orientation sensor 118, input device(s) 120, media tray 122 (which may include additional storage devices such as CD-ROM drives, multi-media interfaces, etc.), motion sensor 124, and external USB port(s) 126. Input devices 120 include keyboard layer 310 that, in one embodiment, provides a platform for the information handling system when the information handling system is configured in a laptop configuration. Also, in one embodiment, keyboard layer 310 is a hinged component that can be rotated, or moved, respective to touch layer 320 and display screen layer 330. In one embodiment, touch layer 320 is a rigid layer, while in an alternate embodiment, touch layer 320 is flexible. In one embodiment, touch layer 320 is coupled to at least one of the other components (touch screen display 110 or keyboard component 310) with a hinge, while in another embodiment the touch layer is coupled to at least one of the other components with another type of attachment mechanism.

Touch screen display 110 includes touch layer 320 which is a touch-sensitive grid that can be rotated by a hinge to overlay either keyboard layer 310 or display screen layer 330. Touch screen display 110 allows a user to enter inputs by directly touching touch screen display 110. In one embodiment, keyboard layer 310, touch layer 320, and display screen layer 330 are each attached via sets of hinges that allows each of these layers to be rotated, or moved, respective to the other layers.

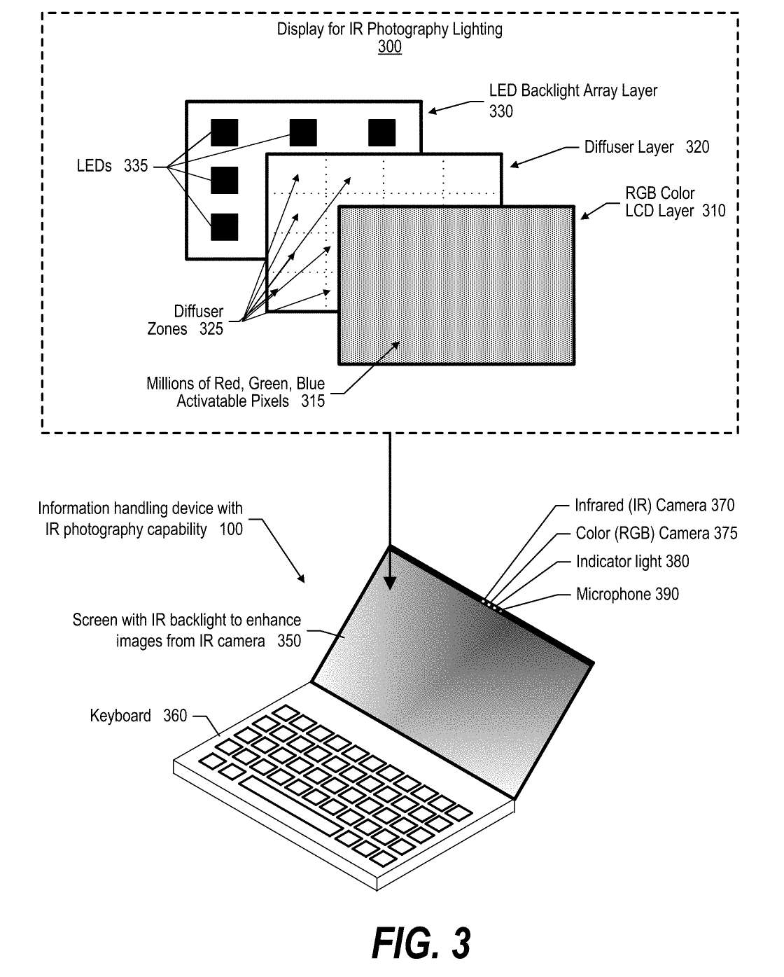

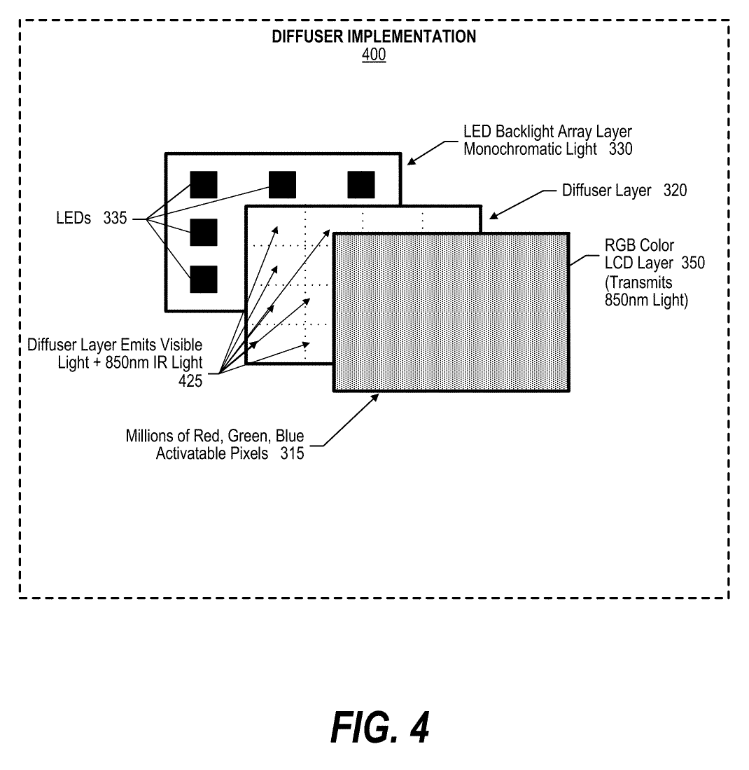

Orientation sensor(s) 118 are one or more sensors and/or associated logic that senses the physical/spatial orientation of information handling system 100. For example, a simple gravity detector can tell if the information handling system is being held right-side-up, upside down, parallel to or perpendicular to the ground (e.g., a walking surface), at some other angle relative to the ground, etc. In another example, orientation sensor 118 is a set of accelerometers, strain gauges, etc. that provide real-time information describing the physical orientation of information handling system 100 in three-dimensional space, including such orientation with respect to the earth/ground/floor. In addition, one or more orientation sensors 118 are used to depict the current configuration of the information handling system with a hinge connecting keyboard layer 310, touch layer 320, and display screen layer 330. These orientations provide orientation data pertaining to the various layers to ascertain, for example, if touch layer 320 is overlaying keyboard layer 310 or display screen layer 330. One or more of these orientation sensors determine if the display screen layer is positioned in a “portrait” mode or a “landscape” mode. Furthermore, data from orientation sensors 118 is used to determine if the information handling system is positioned in a traditional laptop mode (see examples, FIG. 3), a closed or “transport” mode (see example, FIG. 4), a standing or “yoga” mode (see example, FIG. 4), or some other physical configuration.

Motion sensor(s) 124 include one or more sensors and/or associated logic that senses the direction, speed, and/or acceleration of movement of information handling system 100 and components such as the keyboard layer, touch layer, and display screen layer. For example, a combination of accelerometers, strain gauges, etc. (described above with respect to orientation sensor 118) can also be used to detect how fast and in what direction information handling system 100 or the individual components is moving, as well as the acceleration of movement of information handling system 100 or the individual components. For example, motion sensor 124, either alone or in combination with the orientation sensor 118 described above, is able to detect if information handling system 100 is being handed from one person to another based on the rate of acceleration during the hand-off (e.g., faster than normal walking acceleration), the yaw orientation of information handling system 100 during the hand-off (e.g., a rotating movement indicating that the computer is being turned around for another person to see during a hand-off of the computer from one person to another), the pitch orientation of information handling system 100 during the hand-off (e.g., the front of information handling system 100 being tilted upwards during the hand-off of the computer from one person to another), and/or the roll orientation of information handling system 100 during the hand-off (e.g., a side of the computer rolling upwards during the hand-off of the computer of the computer from one person to another). In one embodiment, motion sensor 124 (alone or in combination with orientation sensor 118) is able to detect an oscillating motion of information handling system 100, such as that motion created with a user is walking and holding a tablet computer in her hand (and at her side) while swinging her arms forward and backward. In addition, motion sensors 124 is able to detect the movement of one or more of the layers included in the information handling system (keyboard layer 310, touch layer 320, and display screen layer 330). For example, motion sensors 124 can detect if the user is moving the touch layer in a direction to overlay the keyboard layer or the display screen layer. Likewise, motion sensors can detect that the user is moving the layers to position the information handling system in a traditional laptop orientation, a tablet orientation, a clamshell or “transport” orientation, or any other orientation possible with the information handling system. Information handling system 100 may be a tablet computer, a laptop computer, a smart phone, or any other computing device that has a keyboard layer, a touch layer, and a display screen layer.

Nonvolatile storage interface 132 is also coupled to system bus 106. Nonvolatile storage interface 132 interfaces with one or more nonvolatile storage devices 134. In one embodiment, nonvolatile storage device 134 populates system memory 136, which is also coupled to system bus 106.

System memory includes a low level of volatile memory. This volatile memory also includes additional higher levels of volatile memory, including cache memory, registers and buffers. Data that populates system memory 136 includes information handling system 100's operating system (OS) 138 and application programs 144. OS 138 includes a shell 140, for providing transparent user access to resources such as application programs 144. As depicted, OS 138 also includes kernel 142, which includes lower levels of functionality for OS 138, including providing essential services required by other parts of OS 138 and application programs 144, including memory management, process and task management, disk management, and mouse and keyboard management.

The hardware elements depicted in information handling system 100 are not intended to be exhaustive, but rather are representative to highlight essential components required by the present invention. For instance, information handling system 100 may include alternate memory storage devices such as magnetic cassettes, digital versatile disks (DVDs), Bernoulli cartridges, and the like. These and other variations are intended to be within the spirit and scope of the present invention.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

FIG. 3 is a diagram depicting components of a screen that have been modified to provide infrared spectrum lighting to use with an integrated infrared camera. Display screen 300 included in information handling system 100 displays data to the user as well as providing a light source for infrared (IR) camera 370 included with the information handling system, such as an integrated solution where the camera is included in a frame of the information handling system display as shown.

Display screen 300 includes a number of layers that provide lighting and display support. Light emitting diode (LED) backlight array layer 330 provides a number of LEDs that can be turned OFF and ON as needed. Diffuser layer 320 diffuses light emanating from LED layer 330 and, in one embodiment, uses a number of diffuser zones 325 to diffuse the light. In one embodiment, the diffuser is designed so that the light passed through diffuser layer 320, when graphed, has a first apex in a first spectrum of visible light and a second apex in a second spectrum of infrared light. This dual-apex light provides both visible spectrum light utilized by the user to view data displayed on the display screen as well as IR spectrum light that provides lighting suitable to the IR camera. Finally, RGB (red-green-blue) color LCD (liquid crystal display) layer 310 is a layer that often includes millions of pixels 315 that are individually activatable. The light provided by LCD backlight array layer 330 passes through diffuser layer 320 that diffuses the light into visible and IR spectums and the light then passes through LCD color layer 310.

Information handling system 100 is shown with panel 350, such as a hingeable panel, that includes display 300 and, as shown in a laptop configuration, can be hinged to keyboard component 360. While a laptop configuration is shown, other configurations such as a desktop or tablet configuration can also utilize display 300 described above to provide IR spectrum light for IR photography captured by IR camera 370. In addition, color digital camera 375 can also be included in information handling system 100. Indicator light 380 can be used to indicate when one of the cameras (IR camera 370 and/or color camera 375) is in use. Microphone 390 is used to capture audio from the user, such as with a video chat application.

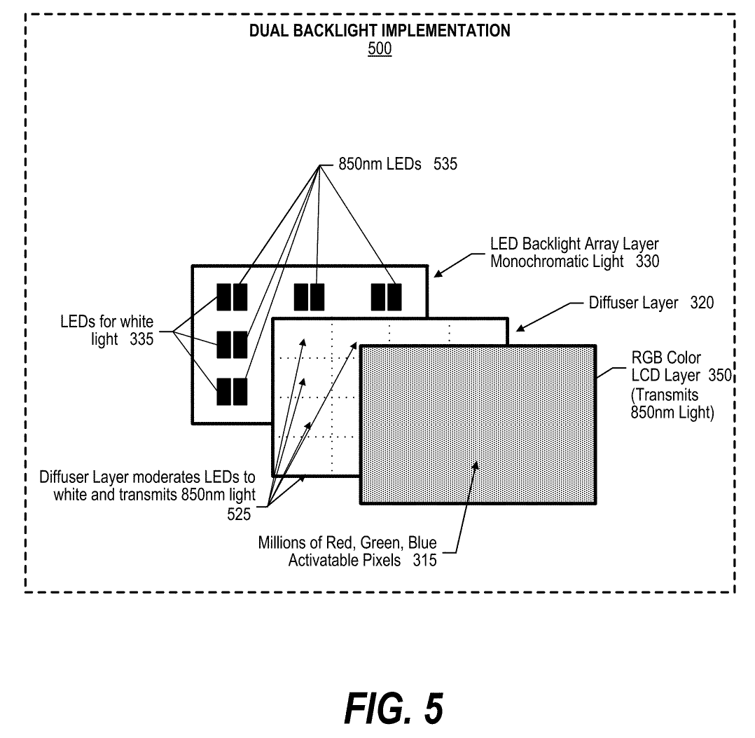

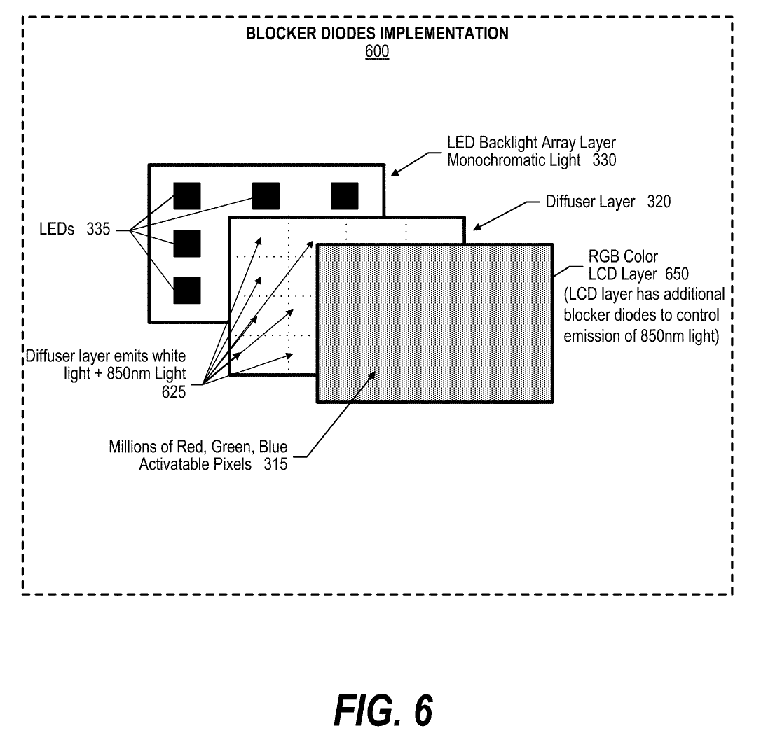

FIG. 4 is a diagram depicting a diffuser implementation that uses a modified diffuser layer to emit infrared spectrum lighting from the display screen. Three different implementation options are shown with a diffuser implementation being shown in FIG. 4, a dual backlight implementation shown in FIG. 5, and a blocker diodes implementation shown in FIG. 6.

In diffuser implementation 400, diffuser layer 320 is utilized to diffuse the light emanating from LED backlight array layer 330 into visible light spectrum light as well as IR spectrum light that is, in one embodiment, has a wavelength of approximately 850 nm after the light from backlight layer 330 travels through diffuser zones 425.

FIG. 5 is a diagram depicting a dual backlight implementation that uses a modified diffuser layer and additional infrared backlights to emit infrared spectrum lighting from the display screen. In dual backlight implementation 500, two different types of LED lights are included in backlight layer 330. Traditional LEDs 335 provide white light in the visible spectrum, while LEDs 535 provide light in the IR spectrum that, in one embodiment, has a wavelength of approximately 850 nm. Diffuser layer zones 525 included in diffuser layer 320 moderates the light that passes through the diffuser layer from the backlight layer to transmit both white, or visible spectrum, light, as well as IR spectrum light that is, in one embodiment, has a wavelength of approximately 850 nm.

FIG. 6 is a diagram depicting a blocker diodes implementation that uses a modified diffuser layer and blocker diodes incorporated in the LCD layer to emit infrared spectrum lighting from the display screen. In blocker diodes implementation 600, backlight layer 330 has backlight LEDs that transmit traditional white light, diffuser layer 320 has diffuser layer zones 625 that emit both white, or visible spectrum, light as well as IR spectrum that, in one embodiment, has a wavelength of approximately 850 nm. In this implementation, LCD layer 650 has both traditional RGB pixels that are individually activatable as well as additional “blocker diodes” that control the emission of IR spectrum light (e.g., light with a wavelength of approximately 850 nm, etc.) through the LCD layer.

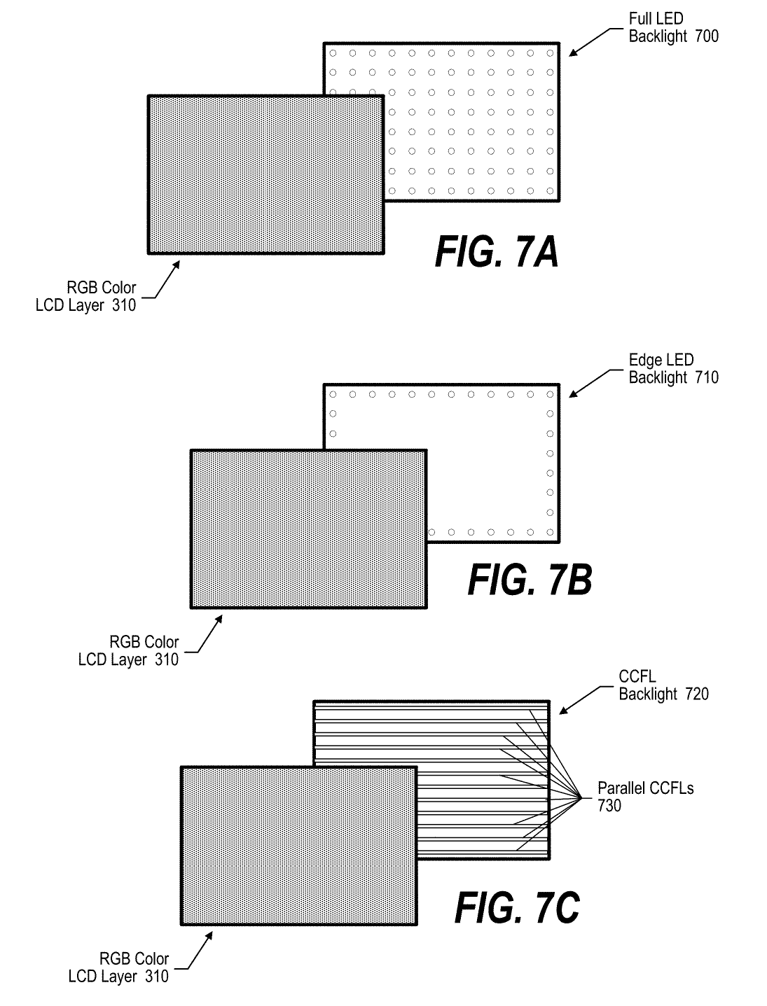

FIGS. 7A-7C depict various backlighting techniques that can be used as backlights to provide infrared spectrum lighting. FIG. 7A depicts backlight 700 that has a full backlight of LEDs, both along the edges of the display area as well as in the middle area of the display. FIG. 7B depicts edge LED backlight 710 that has LEDs along the edge of the display area. Finally, FIG. 7C depicts CCFL (Cold Cathode Fruorescent Lamps) backlight 720. In one embodiment, parallel CCFL lamps 730 are positioned, such as horizontally as shown, to provide backlight for the display.

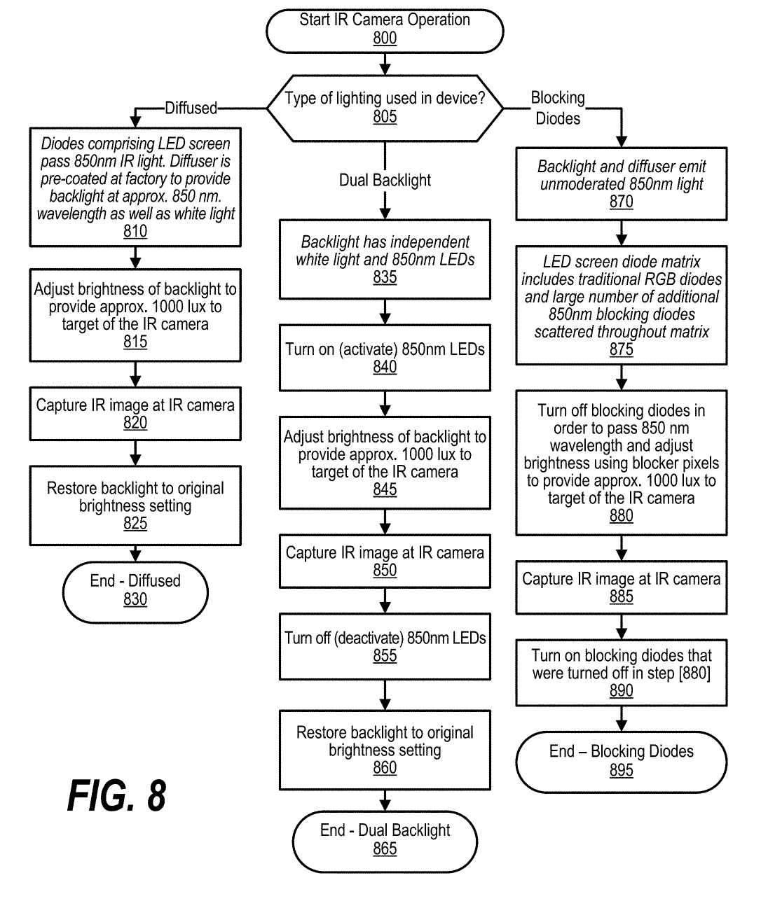

FIG. 8 is a flowchart showing steps performed when providing infrared spectrum lighting utilizing the diffused, dual backlight, or blocker diodes implementations. FIG. 8 processing commences at 800 and shows the steps taken by a process that starts an infrared (IR) camera operation at an information handling system. At step 805, the process determines the type of lighting that is being used in the device, such as at a laptop computer system, to provide IR spectrum light for use by an IR camera. If diffused type of backlighting approach is being utilized, then decision 805 branches to the ‘diffused’ branch to process steps 810 through 830. In this approach, as shown at step 810, the diodess comprising the LED screen allow 850 nm IR light to pass through the LED layer. The diffuser is pre-coated at the factory to provide backlighting at a wavelength of approximately 850 nm as well as allowing white light to pass through the layer. At step 815, the process adjusts the brightness of the backlight to provide approximately 1,000 lux to the target, or subject, of the IR camera. For example, if the target is a person sitting in front of the camera, then the backlight provides approximately 1,000 lux at the person's face. At step 820, the process captures an IR image using the IR camera. At step 825, the process restores the backlight brightness to the original brightness setting. The diffused approach shown in FIG. 8 thereafter ends at 830.

If dual backlight type of backlighting is being utilized, then decision 805 branches to the ‘dual backlight’ branch to process steps 835 through 865. In this approach, as shown at step 835, the process backlights has independent white light and 850 nm LEDs. At step 840, the process turns on, or activates, the 850 nm LEDs included in the baclight layer. At step 845, the process adjusts the brightness of the backlight to provide approximately 1,000 lux to the target, or subject, of the IR camera. For example, if the target is a person sitting in front of the camera, then the backlight provides approximately 1,000 lux at the person's face. At step 850, the process captures an IR image using the IR camera. At step 855, the process turns off, or deactivate, the 850 nm LEDs that were activated back on step 840. At step 860, the process restores the backlight brightness to the original brightness setting. The dual backlight approach shown in FIG. 8 thereafter ends at 865.

If a blocking diodes approch backlighting is being utilized, then decision 805 branches to the ‘blocking diodes’ branch to process steps 870 through 895. In this approach, as shown at step 870, the process backlights and diffuser emit unmoderated 850 nm light. As shown at step 875, in this approach the LEDs screen diode matrix includes both traditional RGB diodes as well as a large number of additional 850 nm blocking diodes that are scattered throughout the diode matrix. At step 880, the process turns off the blocking diodes in order to allow light with a wavelength of approximately 850 nm to pass through the LCD layer and the process further adjusts the brightness using the blocker pixels to provide approximately 1,000 lux to target of the IR camera. At step 885, the process captures the IR image at the IR camera. At step 890, the process turns on the blocking diodes that were turned off in step 880. Now, with the blocking diodes turned on, light in the IR spectrum will be blocked from passing through the LCD layer. The blocking diodes approach shown in FIG. 8 thereafter ends at 895.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. An apparatus comprising:
a display screen component that includes:
a backlight layer;
a diffuser layer, wherein the diffuser layer emits both visible spectrum light and infrared spectrum light through the diffuser; and
a liquid crystal layer.

2. The apparatus of claim 1 wherein the diffuser layer further comprises:
a plurality of diffuser zones, wherein each of the diffuser zones corresponds to one or more of a plurality of light sources included in the backlight layer, and wherein each of the diffuser zones converts light emitted from the light sources into the visible and infrared spectrum light.

3. The apparatus of claim 1 further comprising:
a light source comprising a plurality of light emitting diodes (LEDs) included in the backlight layer, wherein the LEDs are brightness adjustable and provide a suitable infrared image capture brightness.

4. The apparatus of claim 1 further comprising:
a plurality of blocker diodes included in the liquid crystal layer that are electronically activated and control a level of infrared spectrum light emitted through the liquid crystal layer from the diffuser layer.

5. The apparatus of claim 1 wherein the backlight layer further comprises:
a first light source comprising a first plurality of light emitting diodes (LEDs) that emit light in a visible spectrum; and
a second light source comprising a second plurality of LEDs that emit light in an infrared spectrum.

6. The apparatus of claim 1 wherein the infrared spectrum light is at a frequency greater than 700 nanometers (700 nm).

7. The apparatus of claim 1 further comprising:
one or more processors, wherein the display component is accessible by at least one of the processors;
a memory accessible by at least one of the processors; and
a digital infrared camera accessible by at least one of the processors.

8. The apparatus of claim 7 further comprising:
a set of instructions stored in the memory and executable by at least one of the processors to:
capture an IR image at the digital infrared camera; and
store the IR image in the memory.

9. The apparatus of claim 8 further comprising instructions stored in the memory and executable by at least one of the processors to:
adjust a brightness of the backlight layer to a suitable infrared image capture brightness prior to the capture of the IR image; and
restore the brightness of the backlight layer to a previous level after the capture of the IR image.

10. The apparatus of claim 8 further comprising instructions stored in the memory and executable by at least one of the processors to:
adjust a brightness of the backlight layer to a suitable infrared image capture brightness.

11. The apparatus of claim 8 further comprising
a first light source comprising a first plurality of light emitting diodes (LEDs) that emit light in a visible spectrum; and
a second light source comprising a second plurality of LEDs that emit light in an infrared spectrum, wherein the instructions stored in the memory and executable by at least one of the processors to:
activate the second light source prior to the capture of the IR image; and
deactivate the second light source after the capture of the IR image.

12. The apparatus of claim 8 further comprising:
a plurality of blocker diodes included in the liquid crystal layer that are electronically activated and control a level of infrared spectrum light emitted through the liquid crystal layer from the diffuser layer, wherein the instructions stored in the memory and executable by at least one of the processors to:
deactivate the plurality of blocker diodes prior to the capture of the IR image; and
activate the plurality of blocker diodes after the capture of the IR image.

13. An information handling system comprising:
one or more processors, wherein the display component is accessible by at least one of the processors
a memory accessible by at least one of the processors;
a digital infrared camera accessible by at least one of the processors;
a display screen component that includes:
a backlight layer;
a diffuser layer, wherein the diffuser layer emits both visible spectrum light and infrared spectrum light through the diffuser; and
a liquid crystal layer; and
a set of instructions stored in the memory and executable by at least one of the processors to:
capture an IR image at the digital infrared camera; and
store the IR image in the memory, wherein the display screen component emits an amount of infrared spectrum light suitable to capture IR images by the digital infrared camera.

14. The information handling system of claim 13 further comprising:
the backlight layer of the display screen component further comprising:
a first light source comprising a first plurality of light emitting diodes (LEDs) that emit light in a visible spectrum; and
a second light source comprising a second plurality of LEDs that emit light in an infrared spectrum; and
wherein the instructions stored in the memory and executable by at least one of the processors to:
activate the second light source prior to the capture of the IR image; and
deactivate the second light source after the capture of the IR image.

15. The information handling system of claim 13 further comprising:
the liquid crystal layer of the display screen component further comprising:
a plurality of blocker diodes that are electronically activated and control a level of infrared spectrum light emitted through the liquid crystal layer from the diffuser layer; and
wherein the instructions stored in the memory and executable by at least one of the processors to:
deactivate the plurality of blocker diodes prior to the capture of the IR image; and
activate the plurality of blocker diodes after the capture of the IR image.

16. A method comprising:
emitting a light from a display component of an information handling system, wherein the light is diffused using a diffuser that emits both visible spectrum light and infrared spectrum light;
capturing an infrared (IR) image at an IR camera;
storing the IR image in a memory.

17. The method of claim 16 further comprising:
adjusting a brightness emitted from the display component to a suitable infrared image capture brightness prior to capturing of the IR image; and
restoring the brightness to a previous level after capturing of the IR image.

18. The method of claim 16 further comprising:
activating a set of one or more infrared spectrum lights included in a backlight layer of the display component prior to capturing the IR image; and
deactivating the set of infrared spectrum lights after capturing the IR image.

19. The method of claim 16 further comprising:
deactivating a plurality of blocker diodes included in a liquid crystal display layer of the display component prior to capturing the IR image, wherein the blocker diodes, when activated, block infrared light emitted from one or more other layers of the display component; and
activating the plurality of blocker diodes after capturing the IR image.

20. The method of claim 16 wherein a graph of the light emitted from the display component has a first apex in a first spectrum of visible light and a second apex in a second spectrum of infrared light.

21. The method of claim 16 further comprising:
utilizing an ambient light source in addition to the light emitted from the display to capture the IR image at the IR camera.
